(19) United States
(12) Patent Application Publication
(10) Pub. No.: US 2022/0205902 A1
(43) Pub. Date: Jun. 30, 2022

(54) DETERMINATION OF KINETIC DEGRADATION OF IRON-CARBOHYDRATE COMPLEXES

(71) Applicants: Baxter International, Inc., Deerfield, IL (US); Baxter Healthcare SA, Glattpark (Opfikon) (CH)

(72) Inventor: Robert W. Garber, II, Island Lake, IL (US)

(73) Assignees: Baxter International, Inc., Deerfield, IL (US); Baxter Healthcare SA, Glattpark (Opfikon) (CH)

(21) Appl. No.: 17/560,855

(22) Filed: Dec. 23, 2021

Related U.S. Application Data
(60) Provisional application No. 63/132,782, filed on Dec. 31, 2020.

(51) Int. Cl. G01N 21/31

(52) U.S. Cl. CPC G01N 21/31

(57) ABSTRACT

An analytical method for measuring degradation of iron-carbohydrate complex for intravenous injection may include formulating a reaction solution comprising an iron-carbohydrate complex for intravenous injection, a reducing agent, and a complexing agent. The method may further include measuring absorbance spectral absorbance of an iron-complexing agent species including all or a portion of the complexing agent and iron released from the iron-carbohydrate complex that has been reduced by the reducing agent. Example complexing agents may include 1,10 phenanthroline or ferrozine. An example, iron-carbohydrate complex may be iron sucrose injection.

### CROSS REFERENCE TO RELATED APPLICATIONS

This application claims the benefit of U.S. Provisional Application 63/132,782, filed on Dec. 31, 2020.

### TECHNICAL FIELD

The present application relates to the determination of kinetic degradation of iron-carbohydrate complexes administered to supplement or increase iron levels in humans or animals.

### BACKGROUND

Iron deficiencies are typically treated by increasing bioavailable iron via oral or intravenous iron. For example, iron deficiency anemia is the most common hematological disorder in humans and is often treated with iron supplementation. Other candidates for iron supplementation include certain patients having inflammatory bowel disease, heavy uterine bleeding, bariatric surgeries, or individuals operating in ultra-high altitude environments.

Intravenous iron supplementation is believed to be superior in both safety and efficacy to oral iron supplementation. However, intravenous iron supplementation is not without its drawbacks. Iron acquisition and assimilation in humans is challenging as oxidized iron is poorly soluble at neutral pH and, within the body, free iron is toxic through the promotion of reactive oxygen species.

As therapeutic levels of iron influxes are toxic to the human body, controlled release of free iron is essential. One manner of accomplishing controlled release of iron is by formulating iron-carbohydrate complexes wherein an iron core is surrounded by a carbohydrate shell, such as ferric gluconate or iron sucrose. These nanoparticle shells allow controlled delivery of iron to cells and subsequent delivery to iron-binding proteins ferritin and transferrin.

While accurate measurement of kinetic degradation of iron-carbohydrate complexes is paramount to developing and administering safe intravenous iron supplementation, there are no qualified standards for measuring kinetic degradation of iron-carbohydrate complexes, such as iron sucrose. Current methods of measuring kinetic degradation of these complexes provide only relative measurements and create spectroscopic interference. For example, U.S. Pat. No. 6,911,342 describes a method of measuring kinetic degradation of iron sucrose using direct UV at a wavelength of 450 nm. According to this method, ascorbic acid is added to reduce ferric hydroxide to ferrous hydroxide. This measurement region, however, is in a region of interference. Additionally, the method does not employ standards; thus, allowing only relative measurements.

### SUMMARY

In one aspect, an analytical method for measuring degradation of iron-carbohydrate complexes for intravenous injection may include reducing Fe(III) released from an iron-carbohydrate complex for intravenous injection to Fe(II); complexing the Fe(II) with a complexing agent to generate an iron-complexing agent species including the Fe(II); and measuring spectral absorbance of the iron-complexing agent species.

In one example, the measured spectral absorbance of the iron-complexing agent species may be compared with a standard spectral absorbance of a known concentration of the iron-complexing agent species. In one example, the complexing agent is ferrozine or 1,10 phenanthroline.

In any of the above examples, the method further includes buffering the reaction solution with a buffering agent. Examples of buffering agents include acetate, phosphate, or citrate.

In any of the above examples, reducing the Fe(III) includes reducing the Fe(III) with a reducing agent to reduce the Fe(III) to Fe(II). Examples of reducing agents include ascorbic acid, hydroxylamine, formic acid, thiosulfate, oxalic acid, or combinations thereof.

In any of the above examples, measuring spectral absorbance may include measuring spectral absorbance over time to track rate of degradation of the iron-carbohydrate complex.

In any of the above or another example, spectral absorbance may be measured using well plate or cuvette based techniques.

In any of the above or another example, the spectral absorbance is measured at between about 220 nm and about 650 nm. In one example, the complexing agent may be ferrozine or 1,10 phenanthroline and the spectral absorbance is measured in a range between about 220 nm and about 650 nm.

In any of the above or another example, the complexing agent may be ferrozine and the spectral absorbance is measured at or about 550 nm, and more specifically at or about 562 nm or 1,10 phenanthroline and the spectral absorbance is measured at or about 500 nm, and more specifically at or about 511 nm.

In any of the above or another example, the iron-carbohydrate complex may be in the form of an intravenous injection of an iron-carbohydrate product including iron sucrose. Other examples include administering iron-carbohydrate complexes by oral, parenteral, intramuscular, intravenous, or other suitable means of delivering iron-carbohydrate complexes to humans or animals. Examples of iron-carbohydrate products include iron sucrose, and other carbohydrates suitable for use in administering iron-carbohydrate products to humans or animals for supplementing or increasing iron levels.

In another aspect, an analytical method for measuring degradation of iron-carbohydrate complex for intravenous injection may include formulating a reaction solution comprising an iron-carbohydrate complex for intravenous injection, a reducing agent, and a complexing agent. The method may further include measuring absorbance spectral absorbance of an iron-complexing agent species including all or a portion of the complexing agent and iron released from the iron-carbohydrate complex that has been reduced by the reducing agent.

In one example, the measured spectral absorbance of the iron-complexing agent species may be compared with a standard spectral absorbance of a known concentration of the iron-complexing agent species.

In any of the above or another example, the spectral absorbance is measured at between about 220 nm and about 650 nm. In one example, the complexing agent may be ferrozine or 1,10 phenanthroline and the spectral absorbance is measured in a range between about 220 nm and about 650 nm.

In any of the above or another example, the complexing agent may be ferrozine and the spectral absorbance is measured at or about 550 nm, and more specifically at or about 562 nm or 1,10 phenanthroline and the spectral absorbance is measured at or about 500 nm, and more specifically at or about 511 nm.

In any of the above or another example, the iron-carbohydrate complex for intravenous injection is an iron-carbohydrate injection product including iron sucrose. Other examples include administering iron-carbohydrate complexes by oral, parenteral, intramuscular, intravenous, or other suitable means of delivering iron-carbohydrate complexes to humans or animals. Examples of iron-carbohydrate products include iron sucrose, and other carbohydrates suitable for use in administering iron-carbohydrate products to humans or animals for supplementing or increasing iron levels.

In any of the above or another example, the reducing agent may be selected from ascorbic acid, hydroxylamine, formic acid, thiosulfate, oxalic acid, or combination thereof.

In an above or another example, reaction solution may include a buffering agent. In one example, the buffering agent may be selected from acetate, phosphate, or citrate.

In an above or another example, measuring spectral absorbance may include measuring spectral absorbance over time to track rate of degradation of the iron-carbohydrate complex.

In any of the above or another example, spectral absorbance is measured using well plate or cuvette based techniques.

In any of the above or another example, the iron-carbohydrate complex for intravenous injection is iron sucrose injection.

### BRIEF DESCRIPTION OF THE FIGURES

FIG. 1 shows concentration of Fe(II) over time for sample solution of 1,10 phenanthroline with ascorbic acid using well plate reader.

FIG. 2 shows concentration of Fe(II) over time for sample solution of 1,10 phenanthroline with hydroxylamine using well plate reader.

FIG. 3 shows ultraviolet-visible spectra of the absorbance of Fe(II) over time for sample solution of 1,10 phenanthroline with ascorbic acid using cuvette analysis.

FIG. 4 shows ultraviolet-visible spectra of the absorbance of Fe(II) over time for sample solution of 1,10 phenanthroline with hydroxylamine using cuvette analysis.

FIG. 5 shows concentration of Fe(II) over time for sample solution of ferrozine with ascorbic acid using well plate reader.

FIG. 6 shows concentration of Fe(II) over time for sample solution of ferrozine with hydroxylamine using well plate reader.

FIG. 7 shows concentration of Fe(II) over time for sample solution of ferrozine with ascorbic acid prepared by alternative sample preparation technique using well plate reader.

FIG. 8 shows ultraviolet-visible spectra of the absorbance of Fe(II) over time for sample solution of ferrozine with ascorbic acid using cuvette analysis.

FIG. 9 shows ultraviolet-visible spectra of the absorbance of Fe(II) over time for sample solution of ferrozine with hydroxylamine using cuvette analysis.

FIG. 10 shows ultraviolet-visible spectra of the absorbance of Fe(II) continued from FIG. 9 over time for sample solution of ferrozine with hydroxylamine using cuvette analysis.

### DESCRIPTION

Disclosed are systems and methods for measuring the kinetic degradation of iron-carbohydrate complexes using visible spectroscopy after complexation of iron released from degraded iron-carbohydrate complexes with a complexing agent. The systems and methods may be utilized to measure kinetic degradation of iron-carbohydrate complexes, such as iron sucrose, using qualified standards. The complexing agent (e.g. ferrozine or phenanthroline) used is configured to react with iron and may be added to solution including the iron-carbohydrate complex or degradation product thereof to advantageously generate an iron-complexing agent species having an absorbance dissimilar to that of the matrix. Additionally, as the iron of the iron-complexing agent species is elemental ferrous iron, not an iron-carbohydrate complex such as iron sucrose, quantitative standards may be prepared using elemental iron compounds, e.g., ferrous ammonium sulfate hexahydrate or ferric chloride that is reduced. Thus, the systems and methods described herein may be utilized to allow such quantitative measurements to be obtained via spectral analysis in regions with less spectroscopic interferences than current methodologies. The systems and methods according to the present disclosure thus improve upon prior methodologies that provide only a relative degradation amount whereas the approaches using complexing agents described herein may be utilized to provide an absolute concentration.

In one example, a reaction solution including an iron-carbohydrate complex, such as iron sucrose, a reducing agent, and a complexing agent is formulated. As the iron-carbohydrate complexes degrade, these nanoparticles release the ferric iron (Fe(III)) cores. Released ferric iron is then reduced and the resulting ferrous iron (Fe(II)) is complexed with the complexing agent to form an iron-complexing agent species that may be measured using visible spectroscopy. The amount of degradation may then be directly measured by comparison to standards prepared from ferric or ferrous iron compounds providing for a quantitative method.

The reducing agent may be any suitable reducing agent known in the art to reduce ferric iron and that does not significantly interfere with complexation of iron with the complexing agent or accurate spectral analysis. Exemplarily reducing agents include ascorbic acid or hydroxylamine. Additional exemplary reducing agents include formic acid, thiosulfate, or oxalic acid.

The complexing agent is preferably selected to be quantitively measured when complexed with iron at a wavelength that is separated from spectral interferences. The complexing agent should preferably be selected to react with ferrous iron (Fe(II)) to complex with the same rather than with other components of analysis solutions. It will be appreciated that the complexing agent may be directly added to a degradation or sample solution or may be provided in a one or more mixtures of compounds that may react or itself degrade to generate the complexing agent. Such variations are intended to be encompassed with the complexing agent and addition of the complexing agent described herein. The spectral region used for analysis may be determined from an initial spectral analysis of the complexing agent complexed with iron. In various embodiments, the complexing agent may be selected from 1,10 phenanthroline or ferrozine, each being quantitatively measurable spectroscopically when complexed with iron at a wavelength that is significantly separated from interferences. For example, when the complexing agent is 1,10 phenanthroline, the iron-complexing agent species may be measured at an analysis wavelength of or about 220 nm to about 650 nm, and more specifically at or about 500 nm, and when the complexing agent is ferrozine, the iron-complexing agent species may be measured at an analysis wavelength of or about 220 nm to about 650 nm, and more specifically at or about 550 nm. Any wavelength in a complexed peak may be utilized for the spectral analysis. For example, an apex peak within a complexed peak for iron-ferrozine may be about 562 or an apex peak with a complexed peak for iron-phenanthroline may be about 511 nm.

Spectrometers are known in the art. Spectral analysis may be performed using any suitable spectrometer. The analysis may be performed using conventional (cuvette based), well plate UV, flow injection analysis other suitable methodology for performing spectral analysis according to the present disclosure.

In various embodiments, the reaction solution may include a buffering agent. The buffering agent may be selected for providing a suitable pH for the reduction of the ferric iron and/or complexation of the reduced iron and the complexing agent. The buffering is preferably selected as one that does not interfere with the ability to perform spectral analysis at a desired peak or peak region corresponding to the iron-complexing agent species. An exemplary buffering agents include acetate buffer solutions, such as a 0.2 M acetate solution. Additional exemplary buffering agents include phosphate, formate, malate, propionate, succinate, piperazine, ammonium hydroxide, carbonate, borate or citrate buffering solutions.

In some embodiments, alkalizing or acidifying agents may be used to adjust pH of the buffering solution or reaction solution. Those having skill in the art will appreciate that adjustments in pH buffering agents, reducing agents, and/or complexing agents are susceptible to pH adjustment in a manner suitable to achieve the desired quantification of degradation product complexed with the complexing agent.

In various embodiments, the reaction solution may include a diluent. Dilution may be used, for example, to conform with limitations of analysis equipment such as spectrometers, or to achieve desired concentrations of reaction and/or reagent solution components. The diluent used may be any suitable diluent determined by those having skill in the art. When the systems and methods described herein are utilized to measure kinetic breakdown of an iron-carbohydrate complex in biological environments, such as human circulation or other biological fluid, the diluent may be a biologically acceptable solution or solution that mimics or otherwise does interfere with in vivo biological degradation. Exemplary diluents may include aqueous diluents such as 0.9% saline. In various embodiments, other saline concentrations may be used or differing salts, e.g., KCl, or dextrose may also be used in various embodiments.

The systems and methods described herein may include generation and/or comparison of measured absorbances with standards for quantitative determination. For example, a ferric or ferrous iron solution may be prepared using any suitable iron containing compounds, such as ferrous ammonium sulfate or ferric chloride; however, other sources of iron may be used, such as, for example, ammonium ferric citrate, ferric oxide, ferrous sulfate, ferrous chloride as well as their respective hydrated forms. These compounds may be dissolved in dilute HCl, sulfuric acid, or other suitable acid. Water or other suitable aqueous diluent may be added to a achieve a desired concentration of elemental iron in the stock standard iron solution. This stock standard iron solution may be used to formulate a standard iron solution to include suitable amounts and concentrations of the components of the reaction solution by combining the initial standard solution with suitable amounts and/or concentrations of the reducing agent, complexing agent, and/or other components of the reaction solution. With respect to ferrous iron (Fe(II)) compounds, the iron is already reduced and thus a reducing agent is not a requirement for reducing the iron. However, in some embodiments reducing agent may also be added to stock ferrous iron (Fe(II) solutions. When the reaction solution includes other components such as a buffering agent or diluent, such other components may also be used. In various embodiments, the initial standard solution or a resulting standard solution including one or more components of the reaction solution may be further diluted in 0.9% sodium chloride or other diluent, which may or may not correspond to a diluent utilized to achieve the desired concentration of elemental iron. A ferrous iron standard may include, for example, a predetermined amount of ferrous iron, which may be provided by a stock standard ferrous iron solution, buffer agent, complexing agent, and diluent to a predetermined volume. A ferric iron standard may include, for example, a predetermined amount of ferric iron corresponding to the predetermined amount of ferrous iron, buffer agent, reducing agent to reduce the ferric iron to ferrous iron, complexing agent to complex with the ferrous iron, and diluent to the predetermined volume. In one embodiment, standards may be generated that could vary the compound used for the standard.

It is to be appreciated that while the reaction solution is referenced herein as including the iron-carbohydrate complex, reducing agent, and complexing agent, it is possible to sample a solution of the iron-carbohydrate complex and subsequently add reducing agent and complexing agent together or separate. Similarly, a solution including the iron-carbohydrate complex and reducing agent may be sampled and complexing agent may be subsequently added to the sample. Thus, the description herein with respect to the reaction solution is intended to include such modifications within the meaning of reaction solution.

In some embodiments, the reaction solution may include degradation agents or be placed under degradation conditions to measure degradation in the presences of such agents and/or conditions. For example, degradation of iron-carbohydrate complexes may be measured under various temperatures. In one example, standards may be prepared including similar degradation agents and/or under similar degradation conditions. In another example, the standards are not prepared including similar degradation agents and/or under similar degradation conditions.

In one embodiment, a system of measuring degradation of iron-carbohydrate complexes comprises a kit including one or more reagents described herein with respect to measuring degradation of iron-carbohydrate complexes. For example, the kit may include ferrous and/or ferric standard reagents, complexing agents, reducing agents, buffering agents, or combinations thereof.

In one embodiment, degradation of iron sucrose injection may be measured according to the present disclosure. A sample of iron sucrose injection solution may be suitably diluted if necessary, e.g., to account for limitations of analytical equipment or to achieve a desired concentration. The diluent may be any suitable diluent, such as those described herein. In one example, the diluent is sodium chloride such as 0.9% sodium chloride and is added to 2 mg/mL (as elemental iron). The sample or diluted sample may be further prepared by adding buffering agent, e.g., a buffering agent selected from acetate, phosphate or citrate buffering solutions, reducing agent, e.g., a reducing agent selected from ascorbic acid, hydroxylamine, formic acid, thiosulfate, or oxalic acid, and complexing agent e.g., a complexing agent selected from 1,10 phenanthroline or ferrozine. The solution may be further diluted with a suitable diluent, e.g., 0.9% sodium chloride, potassium chloride, or dextrose.

Standards may be prepared by formulating a ferric or ferrous iron stock standard. In some embodiments, analysis may be performed using one standard basing concentration on the concentration having a linear relationship with respect to absorbance. However, those having skill in the art will appreciate that analysis may utilize more than one standard solution for concentration. For example, if a concentration range is wide, multiple standard solutions may be used to generate a calibration curve. According to one methodology, ferrous ammonium sulfate or ferric chloride compounds may be used to prepare such solutions. These compounds may be dissolved, e.g., in dilute HCl and water to a final concentration corresponding to the that of the starting concentration of the iron sucrose injection or diluted solution thereof, e.g., 2 mg/mL as elemental iron. This stock standard may be used to generate a standard solution(s) by further formulating with components of the sampled reaction solution by further combining buffering agent, reducing agent compound for ferric iron, and complexing agent. The resulting standard solution(s) may be further diluted with suitable diluent. In one example, the buffering agent is acetate buffer, such as 0.2 M acetate buffer solution, the reducing agent is ascorbic acid or hydroxylamine, and complexing agent is 1,10 phenanthroline or ferrozine. The diluent may be 0.9% sodium chloride.

As the nanoparticle degrades, carbohydrate bound ferric iron is released into the solution. This ferric iron is reduced by the reducing agent to ferrous iron. The reduced ferric iron (ferrous iron) reacts with the complexing agent to form an iron-complexing agent species that can be measured using visible spectroscopy. The samples and standards may be analyzed over time to measure degradation.

Analysis may occur at a suitable wavelength based on the complexing agent. For example, about 511 nm may be utilized for iron-1,10 phenanthroline complexes or 562 nm may be utilized for iron-ferrozine complexes. Kinetic degradation may then be measured by determining the time the measured iron degrades to a predetermined concentration. For example, kinetic degradation may be measured until the reaction solution, as determined from the sample, obtains about 15 mg/mL (after accounting for dilution factor) or about 75% iron sucrose degradation of a 20 mg/mL iron sucrose injection product. In this or another example, degradation may be measured until the kinetic degradation, as determined by comparison of the sample concentration with the ferric iron (Fe(III)) standard, achieves about 80% to about 90% concentration of the iron sucrose injection product being analyzed.

### EXAMPLE

### Kinetic Degradation of Iron Sucrose Injection

Iron sucrose injection incudes iron complexed with sucrose. Degradation rate of iron sucrose was determined utilizing iron complexation methodologies described herein using 1,10 phenanthroline or ferrozine complexing agents together with either hydroxylamine and ascorbic acid reducing agents.

The following stock standard solutions were prepared in suitable fractions and amounts. The Fe (III) stock standard included iron chloride hexahydrate dissolved in HCl and was diluted with water to 2.0 mg/mL elemental iron as Fe(III) for well plate ultraviolet analysis and further diluted with water to 0.2 mg/mL elemental iron as Fe(III) for cuvette ultraviolet analysis. The Fe(II) stock standard included ferrous ammonium sulfate dissolved in sulfuric acid and diluted with water to 2.0 mg/mL elemental iron as Fe(II) for well plate ultraviolet analysis and further diluted with water to 0.2 mg/mL elemental iron as Fe(II) for cuvette ultraviolet analysis. The hydroxylamine solution included 10 g of hydroxylamine hydrochloride dissolved and diluted to 100 mL with water. The 0.9% NaCl solution included 0.9 grams of sodium chloride dissolved and diluted to 100 mL with water. The 0.2 M ammonium acetate solution included 3.08 g of ammonium acetate dissolved in 150 mL water, pH adjusted to 9.0-9.5 (ammonium hydroxide), and diluted to 200 mL with water. The stock sample used included 5.0 mL iron sucrose injection and was diluted to volume with 0.9% NaCl to contain 2 mg/mL as elemental iron for well plate ultraviolet analysis and 0.5 mL iron sucrose injection diluted to volume with 0.9% NaCl to contain 0.2 mg/mL as elemental iron for cuvette analysis. The 1,10 Phenanthroline solution included 100 mg of 1,10 phenanthroline dissolved and diluted to 100 mL with water. The ferrozine solution included 494 mg ferrozine dissolved and diluted to 100 mL with 0.2 M ammonium acetate solution.

The 1,10 phenanthroline solution was mixed with an iron containing sample at pH 3-4 and the iron-carbohydrate complex including the reduced iron-1,10 phenanthroline species and was spectrally measured. The apex of about 511 nm was used but any wavelength in the complexed peak corresponding to the iron-1,10 phenanthroline species may be used. The ferrozine solution was mixed with an iron containing sample at pH 6-9 and the iron-carbohydrate complex including the reduced iron-ferrozine species was spectrally measured. The apex of about 562 nm was used but any wavelength in the complexed peak corresponding to the iron-ferrozine species may be used. Target absorbance was 0.1-1.0 AU. The solutions may be adjusted to meet this target. Since the method goal was directed to measuring the reduction of iron, the target absorbance was based on a solution wherein the absorbance is expected to be maximum. Target absorbance was based on Fe(II) standard determined at start of experiment.

TABLE 1
1, 10 Phenanthroline Using Ascorbic acid

| | Fe (II) | Fe (III) | | Fe (II) | | Uncompleted |
|---|---|---|---|---|---|---|
| Solution | Standard | Standard | Sample | Reaction | Blank | Sample |
| Fe (II) Stock Standard | 2.0 | 0.0 | 0.0 | 2.0 | 0.0 | 0.0 |
| Fe (III) Stock Standard | 0.0 | 2.0 | 0.0 | 0.0 | 0.0 | 0.0 |
| Stock Sample | 0.0 | 0.0 | 2.0 | 0.0 | 0.0 | 2.0 |
| 0.2M Acetate Buffer pH 3.6 | 5.0 | 5.0 | 5.0 | 5.0 | 5.0 | 5.0 |
| 1 m Ascorbic Acid | 0.0 | 4.0 | 4.0 | 4.0 | 4.0 | 4.0 |
| 1, 10 Phenanthroline solution | 1.0 | 1.0 | 1.0 | 1.0 | 1.0 | 0.0 |
| Final volume | 50.0 | 50.0 | 50.0 | 50.0 | 50.6 | 50.0 |

| | |
|---|---|
| Diluent | 0.9% NaCl |

Table 1 illustrates the sample methodology utilized for 1,10 phenanthroline complexing agent and ascorbic acid reducing agent along with standards and validating controls. The Fe(II) Standard was prepared by volumetrically pipetting 5 mL of 0.2 M acetate buffer, 2 mL of Fe(II) stock standard, and 1 mL of 1,10 phenanthroline into a 50 mL volumetric flask and diluted to volume with 0.9% NaCl. The Fe(III) Standard was prepared by volumetrically pipetting 5 mL of 0.2 M acetate buffer, 2 mL of Fe(III) stock standard, 1 mL of 1,10 phenanthroline, and 4 mL of ascorbic acid into a 50 mL volumetric flask, and diluting to volume with 0.9% NaCl. The sample was prepared by volumetrically pipetting 5 mL of 0.2 M acetate buffer, 2 mL of sample stock, 1 mL of 1,10 phenanthroline, and 4 mL of ascorbic acid into a 50 mL volumetric flask, and diluting to volume with 0.9% NaCl. The Fe(II) Reaction was prepared by volumetrically pipetting 5 mL of 0.2 M acetate buffer, 2 mL of Fe(II) stock standard, 1 mL of 1,10 phenanthroline, and 4 mL of ascorbic acid into a 50 mL volumetric flask, and diluting to volume with 0.9% NaCl. The Blank was prepared by volumetrically pipetting 5 mL of 0.2 M acetate buffer, 1 mL of 1,10 phenanthroline, and 4 mL of ascorbic acid into a 50 mL volumetric flask, and diluting to volume with 0.9% NaCl. The Uncompleted Sample (uncomplexed control) was prepared by volumetrically pipetting 5 mL of 0.2 M acetate buffer, 2 mL of sample stock, and 4 mL of ascorbic acid into a 50 mL volumetric flask, and diluting to volume with 0.9% NaCl.

TABLE 2
Phenanthroline Using Hydroxylamine

| | Fe (II) | Fe (III) | | Fe (II) | | Uncompleted |
|---|---|---|---|---|---|---|
| Solution | Standard | Standard | Sample | Reaction | Blank | Sample |
| Fe (II) Stock Standard | 2.0 | 0.0 | 0.0 | 2.0 | 0.0 | 0.0 |
| Fe (III) Stock Standard | 0.0 | 2.0 | 0.0 | 0.0 | 0.0 | 0.0 |
| Stock Sample | 0.0 | 0.0 | 2.0 | 0.0 | 0.0 | 2.0 |
| 0.2M Acetate Buffer pH 3.6 | 5.0 | 5.0 | 5.0 | 5.0 | 5.0 | 5.0 |
| Hydroxylamine | 0.0 | 4.0 | 4.0 | 4.0 | 4.0 | 4.0 |
| 1, 10 Phenanthroline solution | 1.0 | 1.0 | 1.0 | 1.0 | 1.0 | 0.0 |
| Final volume | 50.0 | 50.0 | 50.0 | 50.0 | 50.0 | 50.0 |

| | |
|---|---|
| Diluent | 0.9% NaCl |

Table 2 illustrates the sample methodology utilized for 1,10 phenanthroline complexing agent and hydroxylamine reducing agent along with standards and validating controls. The Fe(II) Standard was prepared by volumetrically pipetting 5 mL of 0.2 M acetate buffer, 2 mL of Fe(II) stock standard, and 1 mL of 1,10 phenanthroline into a 50 mL volumetric flask and diluted to volume with 0.9% NaCl. The Fe(III) Standard was prepared by volumetrically pipetting 5 mL of 0.2 M acetate buffer, 2 mL of Fe(III) stock standard, 1 mL of 1,10 phenanthroline, and 4 mL of hydroxylamine into a 50 mL volumetric flask, and diluting to volume with 0.9% NaCl. The sample was prepared by volumetrically pipetting 5 mL of 0.2 M acetate buffer, 2 mL of sample stock, 1 mL of 1,10 phenanthroline, and 4 mL of hydroxylamine into a 50 mL volumetric flask, and diluting to volume with 0.9% NaCl. The Fe(II) Reaction was prepared by volumetrically pipetting 5 mL of 0.2 M acetate buffer, 2 mL of Fe(II) stock standard, 1 mL of 1,10 phenanthroline, and 4 mL of hydroxylamine into a 50 mL volumetric flask, and diluting to volume with 0.9% NaCl. The Blank was prepared by volumetrically pipetting 5 mL of 0.2 M acetate buffer, 1 mL of 1,10 phenanthroline, and 4 mL of hydroxylamine into a 50 mL volumetric flask, and diluting to volume with 0.9% NaCl. The Uncompleted Sample (uncomplexed control) was prepared by volumetrically pipetting 5 mL of 0.2 M acetate buffer, 2 mL of sample stock, and 4 mL of hydroxylamine into a 50 mL volumetric flask, and diluting to volume with 0.9% NaCl.

TABLE 3
Ferrozine Using Ascorbic acid

| | Fe (II) | Fe (III) | | Fe (II) | | Uncompleted |
|---|---|---|---|---|---|---|
| Solution | Standard | Standard | Sample | Reaction | Blank | Sample |
| Fe (II) Stock Standard | 2.0 | 0.0 | 0.0 | 2.0 | 0.0 | 0.0 |
| Fe (III) Stock Standard | 0.0 | 2.0 | 0.0 | 0.0 | 0.0 | 0.0 |
| Stock Sample | 0.0 | 0.0 | 2.0 | 0.0 | 0.0 | 2.0 |
| 0.2M Ammonium Acetate | 5.0 | 5.0 | 5.0 | 5.0 | 5.0 | 5.0 |
| 1 m Ascorbic Acid | 0.0 | 4.0 | 4.0 | 4.0 | 4.0 | 4.0 |
| Ferrozine solution | 1.0 | 1.0 | 1.0 | 1.0 | 1.0 | 0.0 |
| Final volume | 50.0 | 50.0 | 50.0 | 50.0 | 50.0 | 50.0 |

| | |
|---|---|
| Diluent | 0.9 % NaCl |

Table 3 illustrates the sample, reaction, and standards methodology utilized for ferrozine complexing agent and ascorbic acid reducing agent. The solutions in Table 3 were prepares in a manner similar to that described with respect to corresponding solutions shown in Table 1, substituting ferrozine for 1,10 phenanthroline.

TABLE 4
Ferrozine Using Hydroxylamine

| | Fe (II) | Fe (III) | | Fe (II) | | Uncompleted |
|---|---|---|---|---|---|---|
| Solution | Standard | Standard | Sample | Reaction | Blank | Sample |
| Fe (II) Stock Standard | 2.0 | 0.0 | 0.0 | 2.0 | 0.0 | 0.0 |
| Fe (III) Stock Standard | 0.0 | 2.0 | 0.0 | 0.0 | 0.0 | 0.0 |
| Stock Sample | 0.0 | 0.0 | 2.0 | 0.0 | 0.0 | 2.0 |
| 0.2M Ammonium Acetate | 5.0 | 5.0 | 5.0 | 5.0 | 5.0 | 5.0 |
| Hydroxylamine | 0.0 | 4.0 | 4.0 | 4.0 | 4.0 | 4.0 |
| Ferrozine solution | 1.0 | 1.0 | 1.0 | 1.0 | 1.0 | 0.0 |
| Final volume | 50.0 | 50.0 | 500 | 50.0 | 50.0 | 50.0 |

| | |
|---|---|
| Diluent | 0.9% NaCl |

Table 4 illustrates the sample, reaction, and standards methodology utilized for ferrozine complexing agent and hydroxylamine reducing agent. The solutions in Table 4 were prepare in a manner similar to that described with respect to corresponding solutions shown in Table 2, substituting ferrozine for 1,10 phenanthroline.

Spectral analysis was performed utilizing both well plate and cuvette techniques to determine suitability of each for use in the protocol.

Well plate analysis: 250 μL of each solution listed in Tables 1-4 was supplied into well plates at 37° C. Absorbance at 511 nm (1,10 phenanthroline) or 562 nm (ferrozine) was periodically measured and the absorbance and time of analysis was recorded until absorbance of sample is 80-90% of the Fe(III) standard.

Cuvette analysis: the solutions listed in Tables 1-4 were each supplied into 10 mm cuvettes, although other sizes may be used. Absorbance at 511 nm (1,10 phenanthroline) or 562 nm (ferrozine) was periodically measured with a chamber and the absorbance and time of analysis was recorded until absorbance of sample is 80-90% of the Fe(III) standard.

For Samples, Fe(II) Standard, and Fe(II) Reaction samples, the concentration was determined at each timepoint using the Fe(II) standard. Concentration vs elapsed time was plotted. The time of sample preparation was used as time zero (0:00). For samples, slope, correlation coefficient, y and x-intercept were determined using linear regression. The obtained analysis was used to determine degradation rate of iron sucrose injection product as well as suitability of alternate spectral analysis techniques.

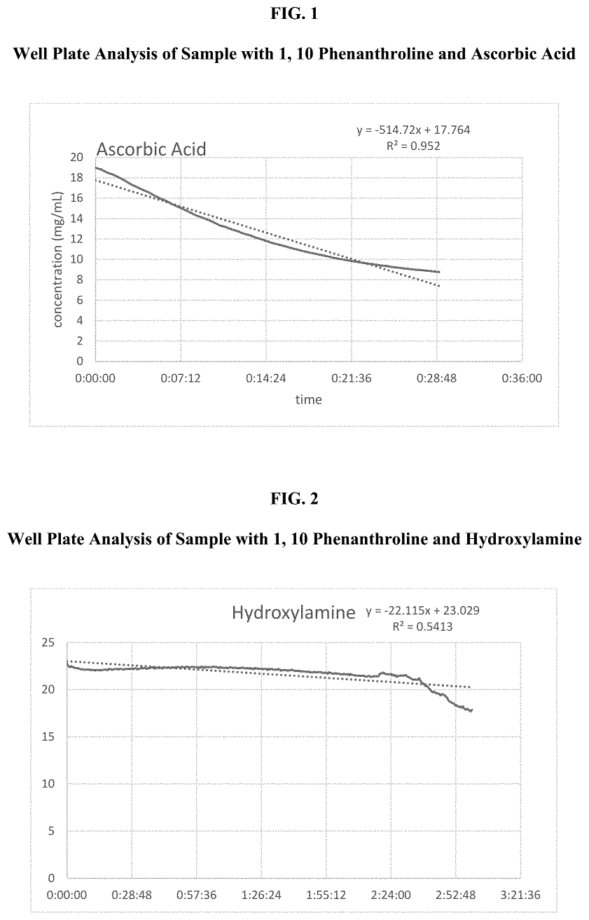

The phenanthroline complex with ascorbic acid and hydroxylamine reducing agents was analyzed using the Spectramax well plate reader at about 511 nm over a period of 3 hours with readings every 30 seconds. The concentration of Fe (II) in the sample was determined against the Fe (II) standard absorption using an external standard approach of known concentration to convert the absorption values provided to concentration of Fe (II). These concentrations were plotted versus elapsed time as shown in FIGS. 1 and 2. In both FIG. 1 and FIG. 2, the absorption and concentration of iron decreased over time.

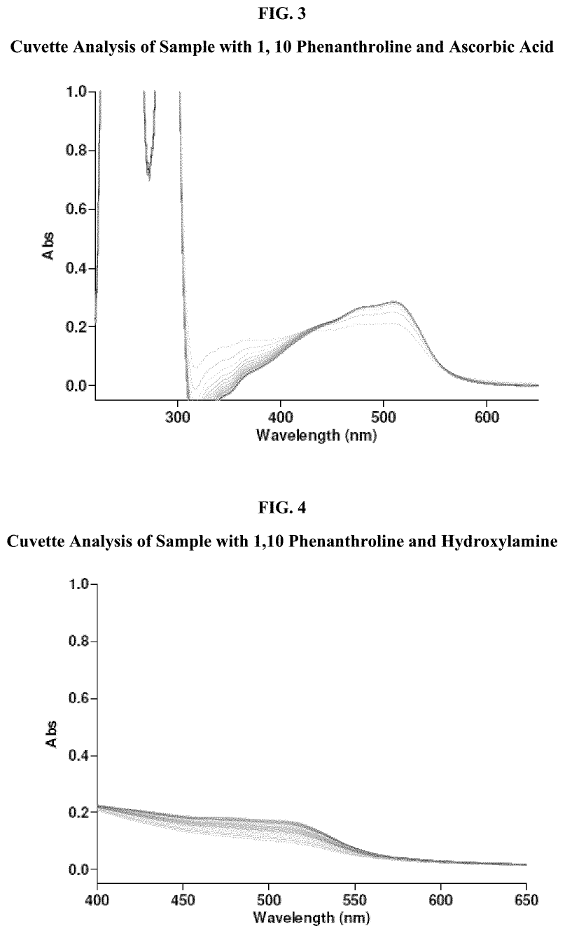

FIG. 3 shows cuvette analysis of sample solution measured with 1,10 phenanthroline complexing agent and ascorbic acid as the reducing agent prepared according to Table 1. Minor adjustments to the standard and stock sample solution concentrations were made to keep the reaction within the linear test region. For example, the concentration of elemental iron was lowered to 0.2 mg/mL. The peak of interest was measured at about 511 nm. FIG. 3 shows the complex of the phenanthroline with the ferrous iron increasing over time. Each line represents a different cycle, measured 2 minutes apart for 60 minutes, which resulted in 30 cycles. The increase occurs from the degradation of the iron sucrose molecule, releasing ferric iron which is then reduced to ferrous iron from the ascorbic acid. The peak at about 511 nm levels out at approximately 0.3 AU.

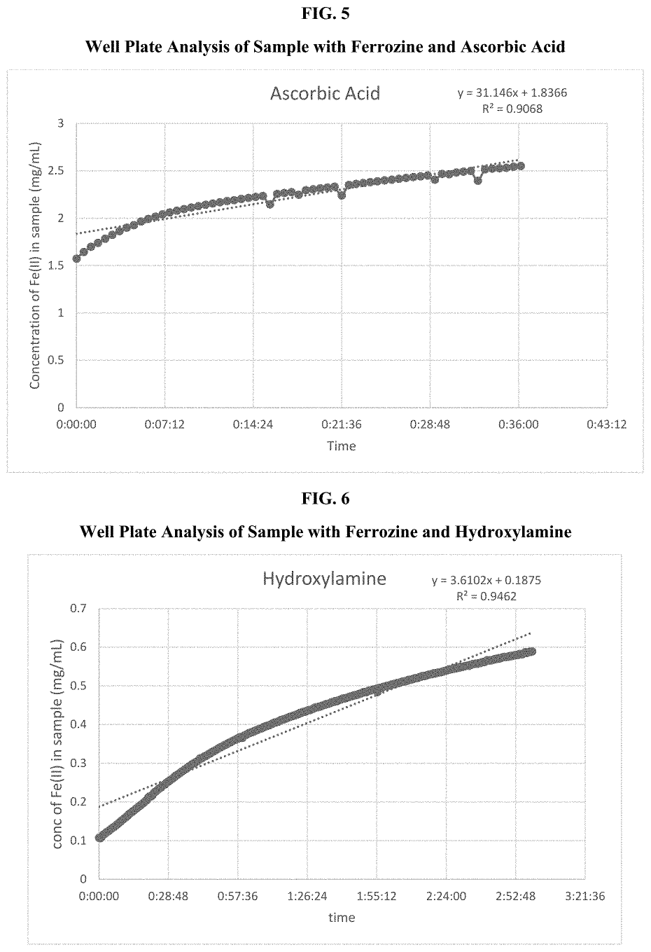

FIG. 4 shows cuvette analysis of the sample solution measured with the 1,10 phenanthroline complexing agent and hydroxylamine as the reducing agent. The peak of interest was measured over time at about 511 nm. Each line represents a different cycle, each measured 2 minutes apart for 60 minutes, for 30 cycles total. Over time, the peak grew at about 511 nm.

Ferrozine as a complexing agent was analyzed similarly to 1,10 phenanthroline with both ascorbic acid and hydroxylamine as reducing agents. Solutions were prepared as stated in Tables 3 and 4. The Spectramax plate reader analyzed the absorbance of the solution at about 562 nm in 30 second intervals. The data from both the Fe(II) standard and the sample were used to determine the concentration of Fe(II) in the sample over time using the same methodology as in the well plate analysis section for the 1,10 phenanthroline method.

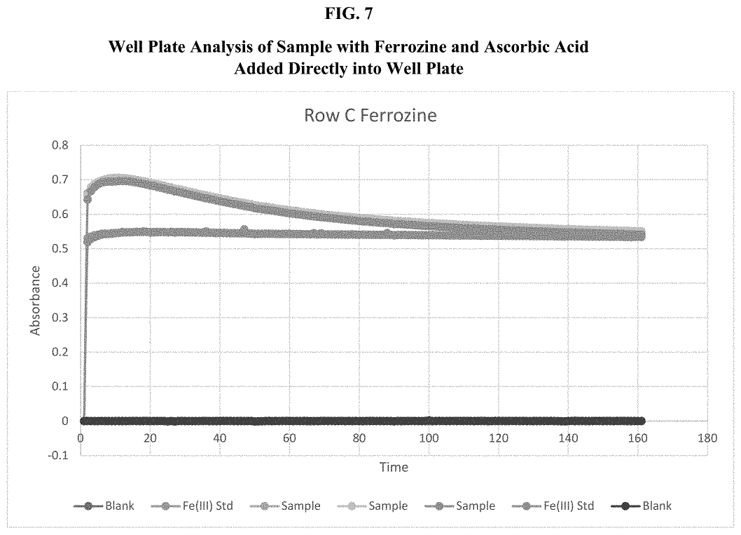

FIG. 5 shows the concentration of Fe(II) in the sample solution over time for the ferrozine with ascorbic acid. FIG. 6 shows the concentration of Fe(II) in the sample over time using the same calculation as described earlier for ferrozine and hydroxylamine as the reducing agent. Due to the faster rate of reaction with ascorbic acid, ferrozine and ascorbic acid were combined and dissolved in 0.2M ammonium acetate. The sample solution was created separately but by doubling the concentration. 125 microliters of each solution (e.g., ferrozine with ascorbic acid and sample with 0.9% sodium chloride) were added directly into the well plate rather than combining the solutions first, then adding 250 microliters into the well plate. As shown in FIG. 7, a larger portion of the reaction was captured using this preparation technique.

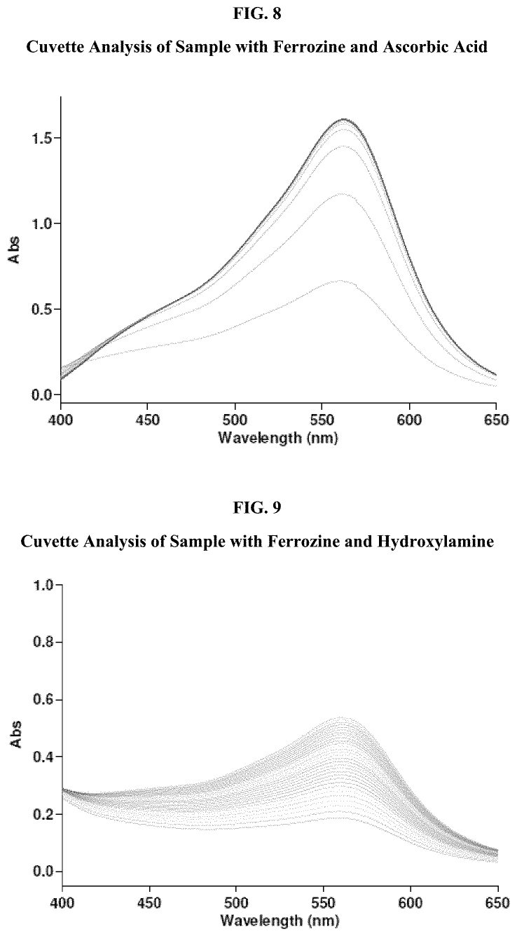

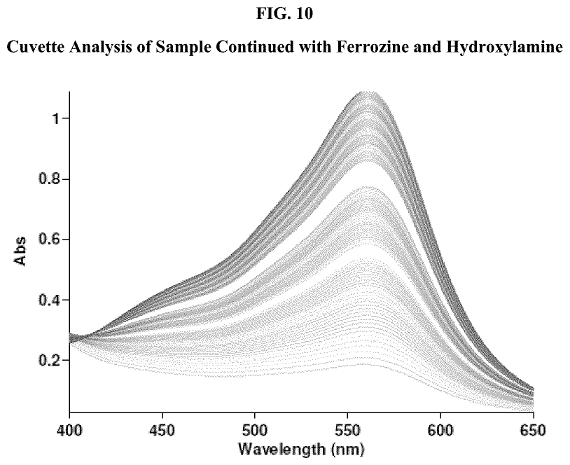

Ferrozine, which reacts with ferrous iron to form a purple solution, was analyzed using the cuvette method with both ascorbic acid and hydroxylamine as reducing agents. FIG. 8 shows the sample solution with ferrozine and ascorbic acid. As above, the data was collected over 30 cycles, 2 minutes each, totaling 60 minutes. As shown in FIG. 8, ferrous iron complexed with ferrozine as shown by absorption at about 562 nm. FIG. 9 shows the sample solution with hydroxylamine as the reducing agent. In FIG. 10, the same solution used in FIG. 9 was analyzed over an extended time, showing the absorption levels of the hydroxylamine reaction had not yet completed in FIG. 9 after 30 cycles of 2 minutes each.

The experimental results evidenced accurate direct quantification of kinetic degradation of the iron-carbohydrate complex iron sucrose in iron sucrose injection may be obtained by spectral analysis of released iron, reduced, and complexed with a complexing agent according to the methodologies described herein.

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth in this specification. Such embodiments may be obtained, for example, by combining, modifying, or reorganizing any of the disclosed steps, components, elements, features, aspects, characteristics, limitations, and the like, of the various non-limiting and non-exhaustive embodiments described in this specification.

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an application of the described embodiments. Further, the use of a singular noun includes the plural, and the use of a plural noun includes the singular, unless the context of the usage requires otherwise. Additionally, the grammatical conjunctions “and” and “or” are used herein according to accepted usage. By way of example, “x and y” refers to “x” and “y”. On the other hand, “x or y” refers to “x”, “y”, or both “x” and “y”, whereas “either x or y” refers to exclusivity.

Any numerical range recited herein includes all values and ranges from the lower value to the upper value. For example, if a concentration range is stated as 1% to 50%, it is intended that values such as 2% to 40%, 10% to 30%, 1% to 3%, or 2%, 25%, 39% and the like, are expressly enumerated in this specification. These are only examples of what is specifically intended, and all possible combinations of numerical values and ranges between and including the lowest value and the highest value enumerated are to be considered to be expressly stated in this application.

The present disclosure may be embodied in other forms without departing from the spirit or essential attributes thereof and, accordingly, reference should be had to the following claims rather than the foregoing specification as indicating the scope of the invention. Further, the illustrations of arrangements described herein are intended to provide a general understanding of the various embodiments, and they are not intended to serve as a complete description. Many other arrangements will be apparent to those of skill in the art upon reviewing the above description. Other arrangements may be utilized and derived therefrom, such that logical substitutions and changes may be made without departing from the scope of this disclosure.

What is claimed is:

1. An analytical method for measuring degradation of iron-carbohydrate complexes for intravenous injection, the method comprising:
reducing in a reaction solution Fe(III) released from an iron-carbohydrate complex for intravenous injection to Fe (II);
complexing the Fe(II) with a complexing agent to generate an iron-complexing agent species including the Fe(II); and
measuring spectral absorbance of the iron-complexing agent species.

2. The method of claim 1, further comprising comparing the measured spectral absorbance of the iron-complexing agent species with a standard spectral absorbance of a known concentration of the iron-complexing agent species.

3. The method of claim 1, wherein the complexing agent comprises ferrozine or 1,10 phenanthroline.

4. The method of claim 1, further comprising buffering the reaction solution with a buffering agent.

5. The method of claim 4, wherein the buffering agent is selected from acetate, phosphate, or citrate.

6. The method of claim 1, wherein reducing the Fe(III) includes reducing the Fe(III) with a reducing agent to reduce the Fe(III) to Fe(II).

7. The method of claim 6, wherein the reducing agent is selected from ascorbic acid, hydroxylamine, formic acid, thiosulfate, oxalic acid, or combination thereof.

8. The method of claim 1, wherein measuring spectral absorbance includes measuring spectral absorbance over time to measure rate of degradation of the iron-carbohydrate complex.

9. The method of claim 1, further comprising preparing the reaction solution, wherein the reaction solution includes the iron-carbohydrate complex, complexing agent, a reducing agent, and a buffering agent.

10. The method of claim 9, wherein the reducing agent is selected from ascorbic acid, hydroxylamine, formic acid, thiosulfate, oxalic acid, or combination thereof.

11. The method of claim 1, wherein the spectral absorbance is measured using well plate or cuvette based techniques.

12. The method of claim 1, wherein the complexing agent comprises ferrozine and the spectral absorbance is measured at or about 562 nm or the complexing agent comprises 1,10 phenanthroline and the spectral absorbance is measured at or about 511 nm.

13. The method of claim 1, wherein the iron-carbohydrate complex for intravenous injection comprises iron sucrose injection.

14. An analytical method for measuring degradation of iron-carbohydrate complex for intravenous injection, the method comprising:
formulating a reaction solution comprising an iron-carbohydrate complex, a reducing agent, and a complexing agent; and
measuring spectral absorbance of an iron-complexing agent species including all or a portion of the complexing agent and iron released from the iron-carbohydrate complex that has been reduced by the reducing agent.

15. The method of claim 14, further comprising comparing the measured spectral absorbance of the iron-complexing agent species with a standard spectral absorbance of a known concentration of the iron-complexing agent species.

16. The method of claim 14, wherein the complexing agent comprises ferrozine and the spectral absorbance is measured at or about 562 nm or the complexing agent comprises 1,10 phenanthroline and the spectral absorbance is measured at or about 511 nm.

17. The method of claim 14, wherein the reducing agent is selected from ascorbic acid, hydroxylamine, formic acid, thiosulfate, oxalic acid, or combination thereof.

18. The method of claim 14, wherein measuring spectral absorbance includes measuring spectral absorbance over time to measure rate of degradation of the iron-carbohydrate complex.

19. The method of claim 14, wherein spectral absorbance is measured using well plate or cuvette based techniques.

20. The method of claim 14, wherein the iron-carbohydrate complex for intravenous injection comprises iron sucrose injection.
